(19) United States
(12) Patent Application Publication
(10) Pub. No.: US 2024/0346338 A1
(43) Pub. Date: Oct. 17, 2024

(54) MODEL FEATURE ANALYSIS AND CLUSTERING TOOLS FOR REFINING OUTPUTS OF MACHINE LEARNING MODELS

(71) Applicant: The Toronto-Dominion Bank, Toronto (CA)

(72) Inventors: SNEHA DESAI, Toronto (CA); Hanif Remtulla, New York, NY (US); Miyuki Kimura, Toronto (CA)

(21) Appl. No.: 18/301,413

(22) Filed: Apr. 17, 2023

(51) Int. Cl. G06N 5/022; G06N 5/04; G06Q 30/0601

(52) U.S. Cl. CPC G06N 5/022; G06N 5/04; G06Q 30/0631

(57) ABSTRACT

The present disclosure generally relates to systems, software, and computer-implemented methods for using resource-efficient model feature evaluation and clustering techniques to refine outputs of machine learning models. One example method includes receiving a set of data relating to a user and a particular item. The set of data can be input to a predictive model. A model output specifying a particular likelihood that the user will obtain the particular item can be obtained from the predictive model. Scores for a set of features of the predictive model can be computed based on the model output. A cluster can be identified from among a plurality of clusters using a clustering model. The customized recommendation can be generated for the user to obtain the particular item based on the identified cluster. The customized recommendation can be transmitted via a network interface and to a device corresponding to the user.

### TECHNICAL FIELD

The present disclosure generally relates to data processing techniques and provide computer-implemented methods, software, and systems for using resource-efficient model feature evaluation and clustering techniques to refine outputs of machine learning models.

### BACKGROUND

Data modelling involves design of algorithms that adapt machine learning model to improve their ability to process data and make predictions. More specifically, data modeling is an approach to data analysis that involves building and adapting models. Data modelling can be applied to a variety of areas such as recommendation systems, search engines, medical diagnosis, natural language modelling, autonomous driving, etc. One application of machine learning-based model includes recommendation systems. For example, millions of customers acquire items (e.g., products, services, digital content, etc.) and consider numerous providers (e.g., product/service/content providers) for such needs. Customers may not acquire an item from a particular provider for multiple reasons. For example, some customers may receive similar offers from numerous providers, without any incentive or guidance on which of the offers may be superior. Relatedly, and as another example, some customers might have entrenched relationships with one or more providers, and without any personalized offer or incentive to switch to another provider, such customers may acquire items from their existing provider(s).

As these examples illustrate, item recommendations or incentives regarding the same—without any customization specific to a customer to which they are directed—generally have a low success rate (i.e., acceptance rate or acquisition rate). As a result, while such generic recommendations or incentives have low acceptance rates, they can still consume significant computing resources in their generation and provision (as well as the numerous follow-ups that also are often generated and sent).

### SUMMARY

The present disclosure generally relates to systems, software, and computer-implemented methods for using resource-efficient model feature evaluation and clustering techniques to refine outputs of machine learning models, e.g., as deployed in the context of an item recommendation system that identifies an item and/or associated information for a user to obtain an item.

A first example method includes receiving, via a network interface and for a user that is interacting with a particular item of a provider, a set of data relating to the user and the particular item. A customized recommendation for the user that specifies a customized offer for the user to acquire the particular item can be generated, where the generating can include inputting the set of data to a predictive model that generates an output probability specifying a likelihood that the user will obtain an item of the provider. A first model output specifying a particular likelihood that the user will obtain the particular item can be obtained from the predictive model and in response to the input set of data. Scores for a first set of features of the predictive model can be computed based on the first model output, where a score for a particular feature represents a degree to which the particular feature contributed to the first model output. A first cluster can be identified from among a plurality of clusters using a clustering model and based on the first model output and the scores for the first set of features, where each of the plurality of clusters indicates one or more attributes corresponding to users in the cluster. The customized recommendation for the user can be generated based on the identified first cluster to obtain the particular item. The customized recommendation can be transmitted via the network interface and to a device corresponding to the user.

Implementations can optionally include one or more of the following features.

In some implementations, the scores for the first set of features includes Shapley values for the first set of features.

In some implementations, the first example method further includes identifying, based on historical data of Shapley values for a plurality of features, the first set of features from among the plurality of features.

In some implementations, the identification of the first set of features is based on features with Shapley values that have contributions to the first model output of the predictive model that satisfy a predetermined threshold, and the first example method includes reducing a first subset of features to a second subset of features using a correlation analysis that correlates one or more features within the first subset of features, where the second subset of features is the first set of features.

In some implementations, generating the customized recommendation includes generating, based on the identified first cluster and the scores for the first set of features, the customized recommendation.

In some implementations, the clustering model includes a k-means clustering algorithm.

In some implementations, the first example method includes training the predictive model using a set of training data and a corresponding set of labels, where the set of training data includes a plurality of sets of data relating to multiple users and items with which the multiple users interacted, and each label in the corresponding set of labels identifies whether a user of the multiple users acquired a respective item.

In some implementations, the set of data relating to the user and the particular item is obtained at a particular point during a lifecycle for acquisition of the particular item and where the particular point during the lifecycle includes (1) a point in the lifecycle when the user makes an initial request for information regarding the particular item or (2) a point in the lifecycle when the user has submitted an application requesting an offer for the particular item.

In some implementations, the first example method includes determining accuracy of the predictive model at predetermined time intervals, and triggering a re-training of the predictive model in response to determining that the accuracy does not satisfy a predetermined threshold.

In some implementations, the first example method includes comparing actual outcomes indicating whether particular users acquired items with corresponding predicted outputs generated by the predictive model indicating whether the particular users will acquire the items, and triggering a re-training of the predictive model in response to determining that the actual outcomes differ from the predicted outputs by a predetermined threshold.

In some implementations, the first example method includes detecting one or more user operations of the user in response to the customized recommendation, and generating, based on the one or more user operations, training data for re-training at least one of the predictive model or the clustering model.

In some implementations, the one or more user operations include at least one of accepting the customized recommendation or rejecting the customized recommendation.

In some implementations, the particular item includes a financial product, and the first set of features include at least one of a desired interest rate of the user, an interest rate of the financial product, applied loan amount of the user, a desired processing time of the user for an application requesting an offer for the financial product, a credit score of the user, or a location of the user.

Similar operations and processes associated with each example system can be performed in different systems comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations can also be contemplated. Additionally, similar operations can be associated with or provided as computer-implemented software embodied on tangible, non-transitory media that processes and transforms the respective data, some or all of the aspects can be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

The techniques described herein can be implemented to achieve the following advantages. For example, in some cases, the techniques described herein implement resource efficient techniques to utilize feature performance scores (e.g., Shapley values) for model features corresponding to the deployed machine learning model. In general, computing Shapley values for all the model's features can be a computing resource intensive task. In contrast, the techniques described herein utilize historical data as well as localized data to identify those features that have a high contribution (or are expected to have a high contribution) to the model's output. In this manner, the hundreds or thousands of features of a model can be reduced to a substantially smaller subset, e.g., of twenty features. The reduced feature set can be further refined by applying a correlation analysis (e.g., principal component analysis (PCA)) that identifies similar features and in doing so, further reduces the feature set (e.g., to a set of 9-10 features). In this manner, the computation of Shapley values in the present solution is performed with respect to a substantially reduced feature set instead of a larger population of features—without any substantive impact on the solution's overall accuracy.

As another example, in some instances, the techniques described herein can utilize a machine learning-based technique to generate customized recommendations for acquiring items (e.g., products, services, digital content, etc.). Unlike conventional solutions that utilize numerous computing resources to generate and follow-up with respect to unfulfilled, generic item acquisition outreaches, the techniques described herein achieve relative computation efficiencies by generating more customized offer at any point during an item's acquisition lifecycle, which would have a higher likelihood of acceptance (than conventional solutions)—which in turn would require fewer number of computing resources before an item is acquired.

As yet another example, in some implementations, the techniques described herein enable deployment of a high accuracy model that routinely uses a feedback-based implementation to monitor the model accuracy and make improvement thereto, for example, in an online setting. In particular, and in some implementations, the model deployment here can apply and compute model accuracy metrics (e.g., using recent model computations) and use the computed metrics to make real-time adjustments to the model.

Further still, in some instances, the machine-learning based techniques described herein generate customized offers for items—regardless of the amount of information available regarding a particular user. For example, when a model is deployed pursuant to the techniques described herein and is used for generating item acquisition options for a user, the amount of information conveyed by the user varies based on a number of interactions that the user has already had with the system. Nevertheless, regardless of where the user is in the item acquisition lifecycle (e.g., at an initial information request stage, at an application submission and offer request stage, after credit approval has been received, etc.), the model's output is dynamic and actionable at any point in the item acquisition lifecycle—for example, even at an initial information request phase—where the amount of information and data available to make a decision is relatively less than that which may be available at a later stage in the item acquisition lifecycle. In some cases, the model features that contribute the most to output probabilities can vary by the stage of the product acquisition lifecycle. In such case, the techniques described herein can select the model features based on the stage of the product acquisition lifecycle, and use these model features to compute features scores and/or cluster users. Selecting model features suited for a particular stage of the product acquisition lifecycle can enhance the accuracy of the customized recommendation.

### DESCRIPTION OF DRAWINGS

FIG. 1 is a block diagram of a networked environment for customizing a recommendation for a user to obtain an item based on machine learning and clustering techniques.

FIG. 2 illustrates a data and control flow of example interactions performed for customizing a recommendation for a user to obtain an item based on machine learning and clustering techniques.

FIG. 3 illustrates example features at different stages of the item acquisition lifecycle and their corresponding importance.

FIG. 4 illustrates example results of users' feature scores and probabilities.

FIG. 5 is a flow diagram of an example method for customizing a recommendation for a user to obtain an item based on machine learning and clustering techniques.

### DETAILED DESCRIPTION

The present disclosure generally relates to various tools and techniques associated with identifying a user's attribute(s) using machine learning models and customizing a recommendation for the user to obtain an item based on the results of the machine learning models. One example application of the techniques described herein is in the context of offer or recommendation generation systems that generate offers or recommendations for items for a particular user to acquire (e.g., an offer for a user to purchase a residential mortgage loan, an offer to acquire a digital component, etc.). Although the techniques herein are described in the context of this application, it will be appreciated that these techniques are applicable in the context of other applications as well. For brevity and case of description, the following example description is provided in the context of a product offer generation (e.g., a financial product such as a mortgage loan).

In general, the solution described herein can use machine learning and clustering techniques that utilize numerous data points (e.g., channel data, customer data, application data, etc.) at any point during a product offer and acquisition lifecycle, to generate customized offers that incentivize users to acquire a particular product (e.g., a residential mortgage loan). In some implementations, the solution described herein can use a predictive model to generate an output probability indicating whether a user will acquire a particular item based on a set of data related to the user and the particular item. In addition, feature scores (e.g., Shapley values) associated with features of the predictive model (e.g., a machine learning model) that have high contributions to the output probability can be computed, where each feature score represents the feature's contribution to the predictive model's output probability. The feature scores and/or the output probability can be input into a clustering model, which can identify a cluster from among a plurality of clusters, where each of the clusters indicate one or more attributes corresponding to users in the cluster. The identified one or more attributes can subsequently be used to customize a recommendation for the user to obtain the particular item (e.g., providing a particular incentive such as a sign-up bonus that gives the user a certain credit toward a mortgage financing).

To reiterate, these techniques as summarized above and as further described in this specification can be used in the context of financial product offer personalization, in particular, using machine learning and clustering techniques to generate personalized offers that incentivize users to purchase a particular financial product. However, the techniques described herein could be used in offer/recommendation customization for any product, service, or another item (i.e., it need not be limited to financial product offer personalization). One skilled in the art will appreciate that the techniques described herein are not limited to just these applications but can be applicable in other contexts.

For example, in some implementations, the techniques described herein for using machine learning and clustering techniques to generate personalized offers can be extended to making personalized offers to job candidates. In one example use case, the techniques described herein can be used to generate a probability indicating whether a job candidate will accept a job offer based on a set of data related to the job candidate and the job opening. In addition, the techniques described herein can be used to compute feature scores (e.g., Shapley values) associated with features of the predictive model that have high contributions to the output probability. The feature scores and/or the output probability can be input into a clustering model, which can identify a cluster from among a plurality of clusters, each of the plurality of clusters indicating one or more attributes corresponding to job candidates in the cluster. The identified one or more attributes can subsequently be used to customize a personalized offer (e.g., providing a sign-on bonus, providing remote work option, providing extra vacation time, etc.) for the job candidate.

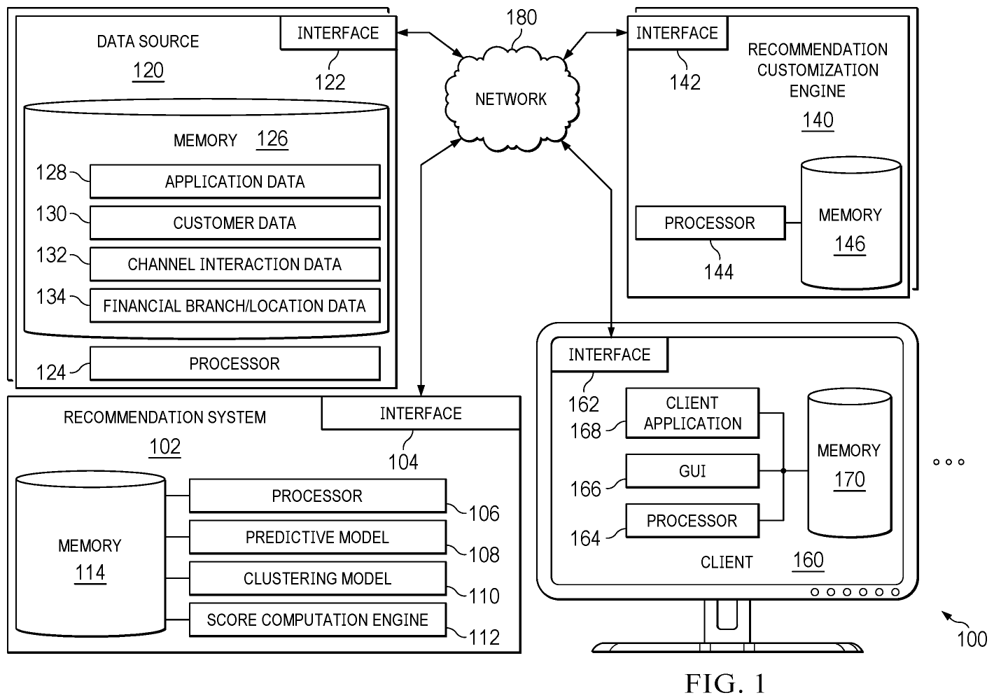

Turning to the illustrated example implementation, FIG. 1 is a block diagram of a networked environment 100 for customizing a recommendation for a user to obtain an item based on machine learning and clustering techniques. As further described with reference to FIG. 1, the environment implements various systems that interoperate to generate a probability indicating whether a user will acquire a particular item, compute feature scores associated with features having high contributions to the output probability, input the feature scores and/or the output probability to a clustering model to identify user attribute(s), and subsequently customize a recommendation for the user to obtain the particular item based on the user attribute(s).

As shown in FIG. 1, the example environment 100 includes a data source 120, a recommendation system 102, a recommendation customization engine 140, and multiple clients 160 that are interconnected over a network 180. The function and operation of each of these components is described below.

In some implementations, the illustrated implementation is directed to a solution where the recommendation system 102 can utilize the data source(s) 120 to obtain (e.g., over a network interface, e.g., interface 104) data relating to the user and the particular item with which the user is interacting (e.g., a product for which the user is reviewing the product information, requesting additional information, completed an application for receiving an offer for the product, etc.), e.g., on a content page provided by a party (e.g., a financial institution). After receiving the set of data from the data source(s) 120, the recommendation system 102 can input the received data into the predictive model 108 (e.g., a machine learning model) that generates an output probability specifying a likelihood that the user will acquire the particular item. In some cases, the received set of data can be converted into a number of feature values (e.g., numerical values) associated with the features of the predictive model 108.

The predictive model 108 can send the model output (e.g., output probability and/or the feature values) to the score computation engine 112. The score computation engine 112 can use the model output to compute feature scores for a first set of features of the predictive model 108. In some implementations, the first set of features can be selected from numerous features represented by the predictive model 108 (as further described below).

The recommendation system 102 can use a clustering model 110 (e.g., a k-means clustering algorithm) that identifies multiple clusters, and further use the computed feature scores (e.g., Shapley values) and/or the model output to assign the user to a particular cluster from among the multiple clusters. Each of the multiple clusters indicates one or more attributes corresponding to users identified in the cluster (e.g., whether the user is price-sensitive, time sensitive, etc.).

The recommendation system 102 can transmit the clustering result (e.g., one or more attributes corresponding to the user) to the recommendation customization engine 140, which can use the clustering result (and in some implementations, the computed feature scores) to generate a customized recommendation for the user, where the customized recommendation specifies a customized offer for the user to acquire the particular item. The recommendation customization engine 140 can transmit the customized recommendation to the client 160. In some cases, the user can perform operation(s) on the customized recommendation (e.g., acceptance or rejection) on the client 160. The recommendation system 102 can detect the user operation(s) and refine the predictive model 108 and/or the clustering model 110 based on the user operation(s).

As described above, and in general, the environment 100 enables the illustrated components to share and communicate information across devices and systems (e.g., the data source 120, the recommendation system 102, the recommendation customization engine 140, and the client 160, among others) via network 180. As described herein, the data source 120, the recommendation system 102, the recommendation customization engine 140, and/or the client 160 can be cloud-based components or systems (e.g., partially or fully), while in other instances, non-cloud-based systems can be used. In some instances, non-cloud-based systems, such as on-premises systems, client-server applications, and applications running on one or more client devices, as well as combinations thereof, can use or adapt the processes described herein. Although components are shown individually, in some implementations, functionality of two or more components, systems, or servers can be provided by a single component, system, or server. Conversely, functionality that is shown or described as being performed by one component, can be performed and/or provided by two or more components, systems, or servers.

As used in the present disclosure, the term “computer” is intended to encompass any suitable processing device. For example, the data source 120, the recommendation system 102, the recommendation customization engine 140, and/or the client 160 can be any computer or processing devices such as, for example, a blade server, general-purpose personal computer (PC), Mac®, workstation, UNIX-based workstation, or any other suitable device. Moreover, although FIG. 1 illustrates a single data source 120, a single recommendation system 102, a single recommendation customization engine 140, and a single client 160, any one of the data source 120, the recommendation system 102, the recommendation customization engine 140, and/or the client 160 can be implemented using a single system or more than those illustrated, as well as computers other than servers, including a server pool. In other words, the present disclosure contemplates computers other than general-purpose computers, as well as computers without conventional operating systems.

Similarly, the client 160 can be any system that can request data and/or interact with the data source 120, the recommendation system 102, the recommendation customization engine 140, and/or the client 160. The client 160, also referred to as client device 160, in some instances, can be a desktop system, a client terminal, or any other suitable device, including a mobile device, such as a smartphone, tablet, smartwatch, or any other mobile computing device. In general, each illustrated component can be adapted to execute any suitable operating system, including Linux, UNIX, Windows, Mac OS®, Java™, Android™, Windows Phone OS, or iOS™, among others. The client 160 can include one or more merchant- or financial institution-specific applications executing on the client 160, or the client 160 can include one or more web browsers or web applications that can interact with particular applications executing remotely from the client 160, such as applications on the data source 120, the recommendation system 102, and/or the recommendation customization engine 140, among others.

As illustrated, the recommendation system 102 includes or is associated with interface 104, processor(s) 106, predictive model 108, clustering model 110, score computation engine 112, and memory 114. While illustrated as provided by or included in the recommendation system 102, parts of the illustrated components/functionality of the recommendation system 102 can be separate or remote from the recommendation system 102, or the recommendation system 102 can itself be distributed across the network 180.

The interface 104 of the skill analysis system 102 is used by the skill analysis system 102 for communicating with other systems in a distributed environment—including within the environment 100—connected to the network 180, e.g., the data source 120, the recommendation customization engine 140, the client 160, and other systems communicably coupled to the illustrated recommendation system 102 and/or network 180. Generally, the interface 104 comprises logic encoded in software and/or hardware in a suitable combination and operable to communicate with the network 180 and other components. More specifically, the interface 104 can comprise software supporting one or more communication protocols associated with communications such that the network 180 and/or interface's hardware is operable to communicate physical signals within and outside of the illustrated environment 100. Still further, the interface 104 can allow the recommendation system 102 to communicate with the data source 120, the recommendation customization engine 140, the client 160, and/or other portions illustrated within the recommendation system 102 to perform the operations described herein.

The recommendation system 102, as illustrated, includes one or more processors 106. Although illustrated as a single processor 106 in FIG. 1, multiple processors can be used according to particular needs, desires, or particular implementations of the environment 100. Each processor 106 can be a central processing unit (CPU), an application specific integrated circuit (ASIC), a field-programmable gate array (FPGA), or another suitable component. Generally, the processor 106 executes instructions and manipulates data to perform the operations of the recommendation system 102. Specifically, the processor 106 executes the algorithms and operations described in the illustrated figures, as well as the various software modules and functionality, including the functionality for sending communications to and receiving transmissions from the data source 120, the recommendation customization engine 140, and/or the client 160, as well as to other devices and systems. Each processor 106 can have a single or multiple cores, with each core available to host and execute an individual processing thread. Further, the number of, types of, and particular processors 106 used to execute the operations described herein can be dynamically determined based on a number of requests, interactions, and operations associated with the recommendation system 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including, e.g., C, C++, JavaScript, Java™, Visual Basic, assembler, Perl®, any suitable version of 4GL, as well as others.

The recommendation system 102 can include, among other components, one or more applications, entities, programs, agents, or other software or similar components configured to perform the operations described herein. As illustrated, the recommendation system 102 includes or is associated with a predictive model 108. The predictive model 108 can be any application, program, other component, or combination thereof that, when executed by the processor 106, enables to compute a probability specifying a likelihood that a user will obtain an item. In some cases, the predictive model 108 can be trained using, for example, the gradient descent algorithm.

The recommendation system 102 can include or be associated with a clustering model 110. The clustering model 110 can be any application, program, other component, or combination thereof that, when executed by the processor 106, enables to identify a cluster from among a plurality of clusters, where each of the plurality of clusters indicates one or more attributes corresponding to users in the cluster.

The recommendation system 102 can include or be associated with a score computation engine 112. The score computation engine 112 can be any application, program, other component, or combination thereof that, when executed by the processor 106, enables to compute scores for a set of features of the predictive model 108.

As illustrated, the recommendation system 102 can also include memory 114, which can represent a single memory or multiple memories. The memory 114 can include any memory or database module and can take the form of volatile or non-volatile memory including, without limitation, magnetic media, optical media, random access memory (RAM), read-only memory (ROM), removable media, or any other suitable local or remote memory component. The memory 114 can store various objects or data associated with the recommendation system 102, including any parameters, variables, algorithms, instructions, rules, constraints, or references thereto. While illustrated within the recommendation system 102, memory 114 or any portion thereof, including some or all of the particular illustrated components, can be located remote from the recommendation system 102 in some instances, including as a cloud application or repository, or as a separate cloud application or repository when the recommendation system 102 itself is a cloud-based system.

Network 180 facilitates wireless or wireline communications between the components of the environment 100 (e.g., between the data source 120, the recommendation system 102, the recommendation customization engine 140, the client 160, etc.), as well as with any other local or remote computers, such as additional mobile devices, clients, servers, or other devices communicably coupled to network 180, including those not illustrated in FIG. 1. In the illustrated environment, the network 180 is depicted as a single network, but can be comprised of more than one network without departing from the scope of this disclosure, so long as at least a portion of the network 180 can facilitate communications between senders and recipients. In some instances, one or more of the illustrated components (e.g., the data source 120, the recommendation system 102, the recommendation customization engine 140, and/or the client 160, etc.) can be included within or deployed to network 180 or a portion thereof as one or more cloud-based services or operations. The network 180 can be all or a portion of an enterprise or secured network, while in another instance, at least a portion of the network 180 can represent a connection to the Internet. In some instances, a portion of the network 180 can be a virtual private network (VPN). Further, all or a portion of the network 180 can comprise either a wireline or wireless link. Example wireless links can include 802.11a/b/g/n/ac, 802.20, WiMax, LTE, and/or any other appropriate wireless link. In other words, the network 180 encompasses any internal or external network, networks, sub-network, or combination thereof operable to facilitate communications between various computing components inside and outside the illustrated environment 100. The network 180 can communicate, for example, Internet Protocol (IP) packets, Frame Relay frames, Asynchronous Transfer Mode (ATM) cells, voice, video, data, and other suitable information between network addresses. The network 180 can also include one or more local area networks (LANs), radio access networks (RANs), metropolitan area networks (MANs), wide area networks (WANs), all or a portion of the Internet, and/or any other communication system or systems at one or more locations.

As noted, the data source 120 can store data including but not limited to application data, customer data, channel interaction data, and financial branch/location data, and transmit, to the recommendation system 102, the data. As illustrated, the data source 120 includes various components, including interface 122 for communication (which can be operationally and/or structurally similar to interface 104), at least one processor 124 (which can be operationally and/or structurally similar to processor(s) 106, and which can execute the functionality of the data source 120), and at least one memory 126 (which can be operationally and/or structurally similar to memory 114). As illustrated, memory 126 stores data including application data 128, customer data 130, channel interaction data 132, and financial branch/location data 134.

As noted, the recommendation customization engine 140 can generate a customized recommendation for a user to obtain an item based on, for example, the identified cluster which the user is in. As illustrated, the recommendation customization engine 140 includes various components, including interface 142 for communication (which can be operationally and/or structurally similar to interface 104), at least one processor 144 (which can be operationally and/or structurally similar to processor(s) 106, and which can execute the functionality of the recommendation customization engine 140), and at least one memory 146 (which can be operationally and/or structurally similar to memory 114).

As illustrated, one or more clients 160 can be present in the example environment 100. Although FIG. 1 illustrates a single client 160, multiple clients can be deployed and in use according to the particular needs, desires, or particular implementations of the environment 100. Each client 160 can be associated with a particular user (e.g., a user who may acquire an item via interactions with the client 160), or can be associated with/accessed by multiple users, where a particular user is associated with a current session or interaction at the client 160. Client 160 can be a client device at which the user is linked or associated. As illustrated, the client 160 can include an interface 162 for communication (which can be operationally and/or structurally similar to interface 104), at least one processor 164 (which can be operationally and/or structurally similar to processor 106), a graphical user interface (GUI) 166, a client application 168, and a memory 170 (similar to or different from memory 114) storing information associated with the client 160.

The illustrated client 160 is intended to encompass any computing device, such as a desktop computer, laptop/notebook computer, mobile device, smartphone, personal data assistant (PDA), tablet computing device, one or more processors within these devices, or any other suitable processing device. In general, the client 160 and its components can be adapted to execute any operating system. In some instances, the client 160 can be a computer that includes an input device, such as a keypad, touch screen, or other device(s) that can interact with one or more client applications, such as one or more mobile applications, including for example a web browser, a banking application, or other suitable applications, and an output device that conveys information associated with the operation of the applications and their application windows to the user of the client 160. Such information can include digital data, visual information, or a GUI 166, as shown with respect to the client 160. Specifically, the client 160 can be any computing device operable to communicate with the data source 120, the recommendation system 102, the recommendation customization engine 140, other client(s), and/or other components via network 180, as well as with the network 180 itself, using a wireline or wireless connection. In general, the client 160 comprises an electronic computer device operable to receive, transmit, process, and store any appropriate data associated with the environment 100 of FIG. 1.

The client application 168 executing on the client 160 can include any suitable application, program, mobile app, or other component. Client application 168 can interact with the data source 120, the recommendation system 102, the recommendation customization engine 140, and/or other client(s), or portions thereof, via network 180. In some instances, the client application 168 can be a web browser, where the functionality of the client application 168 can be realized using a web application or website that the user can access and interact with via the client application 168. In other instances, the client application 168 can be a remote agent, component, or client-side version of the recommendation system 102, or a dedicated application associated with the recommendation system 102. In some instances, the client application 168 can interact directly or indirectly (e.g., via a proxy server or device) with the recommendation system 102 or portions thereof. The client application 168 can be used to view, interact with, or otherwise transact data exchanges with the recommendation system 102, and to allow interactions for generating customized recommendations for users to obtain items via the recommendation customization engine 140.

GUI 166 of the client 160 interfaces with at least a portion of the environment 100 for any suitable purpose, including generating a visual representation of any particular client application 168 and/or the content associated with any components of the data source 120, the recommendation system 102, the recommendation customization engine 140, and/or other client(s) 160. For example, the GUI 166 can be used to present screens and information associated with the recommendation system 102 (e.g., one or more interfaces identifying output probabilities generated by the predictive model 108, clusters generated by the clustering model 110, and/or feature scores generated by the score computation engine 112) and interactions associated therewith, as well as presentations associated with the data source 120 (e.g., one or more interfaces for identifying application data, customer data, channel interaction data, and/or financial branch/location data), and/or recommendation-related presentations associated with the recommendation customization engine 140 (e.g., one or more interfaces displaying customized recommendations for users to obtain items). GUI 166 can also be used to view and interact with various web pages, applications, and web services located local or external to the client 160. Generally, the GUI 166 provides the user with an efficient and user-friendly presentation of data provided by or communicated within the system. The GUI 166 can comprise a plurality of customizable frames or views having interactive fields, pull-down lists, and buttons operated by the user. In general, the GUI 166 is often configurable, supports a combination of tables and graphs (bar, line, pie, status dials, etc.), and is able to build real-time portals, application windows, and presentations. Therefore, the GUI 166 contemplates any suitable graphical user interface, such as a combination of a generic web browser, a web-enable application, intelligent engine, and command line interface (CLI) that processes information in the platform and efficiently presents the results to the user visually.

While portions of the elements illustrated in FIG. 1 are shown as individual components that implement the various features and functionality through various objects, methods, or other processes, the software can instead include a number of sub-modules, third-party services, components, libraries, and such, as appropriate. Conversely, the features and functionality of various components can be combined into single components as appropriate.

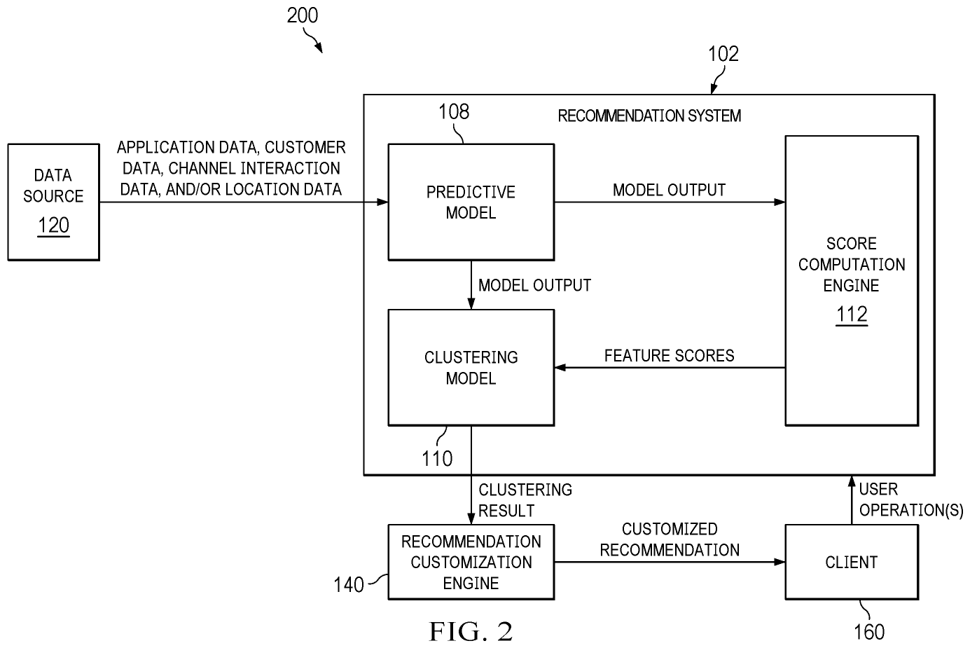

FIG. 2 illustrates an example data and control flow of example interactions 200 performed for customizing a recommendation for a user to obtain an item based on machine learning and clustering techniques. As explained further below, this flow diagram describes generating a probability indicating whether a user will acquire a particular item, computing feature scores associated with features having high contributions to the output probability, inputting the feature scores and/or the output probability to a clustering model to identify user attribute(s), and subsequently customizing a recommendation for the user to obtain the particular item based on the user attribute(s). As illustrated, FIG. 2 shows interactions between the data source 120, the recommendation system 102, the predictive model 108, the clustering model 110, the score computation engine 112, the recommendation customization engine 140, and the client 160.

As illustrated in FIG. 2, the recommendation system 102 can receive a set of data from data source(s) 120 (e.g., one or more data sources). In some examples, the recommendation system 102 can utilize the data source(s) 120 to obtain (e.g., over a network interface) data relating to the user and the particular item with which the user is interacting (e.g., a product for which the user is reviewing the product information, requesting additional information, completed an application for receiving an offer for the product, etc.). In some instances, the data relating to the user can be provided by the user, for example, during an application process for acquiring the particular item. In some instances, the data relating to the user can be retrieved from the user profile (as shared by the user). In some instances, the data relating to the user can be data about contextual environment of the client device over which communication happens (e.g., user's location, time, browsing history, etc.). In some examples, the data relating to the particular item can be retrieved from, for example, an application for acquiring the particular item, a repository (e.g., a database) storing information about the particular item, etc. Examples of data collected via the data sources can include but not limited to application data, customer data, channel interaction data, and financial branch/location data. In some cases, such data can be obtained at any point during a product purchase lifecycle, including, for example, (1) a point in the lifecycle when the user makes an initial request for information regarding the item, (2) a point in the lifecycle when the user has submitted an application requesting an offer for the item, etc. For ease of reference and discussion, the following description describes the operations of the data source 120, the recommendation system 102, the predictive model 108, the clustering model 110, the score computation engine 112, the recommendation customization engine 140, and the client 160, as being performed with respect to a particular user and a particular item. However, it will be understood that the same operations would be performed for other user(s) and/or item(s). In this specification, the term “engine” is used broadly to refer to a software-based system, subsystem, or process that is programmed to perform one or more specific functions. Generally, an engine will be implemented as one or more software components, installed on one or more computers in one or more locations. In some cases, one or more computers will be dedicated to a particular engine; in other cases, multiple engines can be installed and running on the same computer or computers. In some implementations, an engine includes one or more processors that can be assigned exclusively to that engine, or shared with other engines.

After receiving the set of data from the data source(s) 120, the recommendation system 102 can input the received data into the predictive model 108 (e.g., a machine learning model) that generates an output probability specifying a likelihood that the user will acquire the particular item. In some cases, the predictive model 108 can include a number of features indicating characteristics of the user and/or the item, and have weights associated with these features (as determined during model training, which is further described below). In some cases, the item can be a financial product, and examples of the features include the user's relationship with the financial institution providing the financial product, the user's desired interest rate, the interacted-with financial product's interest rate, user's applied loan amount, the interacted-with financial product's loan amount (e.g., maximum allowable loan amount), user's desired processing time for an application requesting an offer for the financial product, user's credit score, user's location, etc.

In some cases, the received set of data can be converted into a number of feature values (e.g., numerical values) associated with the features of the predictive model 108. For example, the user's loyalty to the financial institution can be represented as a number of years that the user has been using the financial institution's product(s) and/or service(s). So, for example, a large number of years indicates a high likelihood of acquiring the financial product by the user, whereas a small number of years indicates a low likelihood of acquiring the financial product by the user. For another example, a difference between the user's desired interest rate and the financial product's interest rate can be calculated as a feature value. So, for example, a large difference indicates a low likelihood of acquiring the financial product by the user, whereas a small difference indicates a high likelihood of acquiring the financial product by the user.

In some implementations, the predictive model 108 can be a machine learning model, and the machine learning model can be trained using a set of training data and a corresponding set of labels, where the training data can include multiple sets of data relating to multiple users and items with which the multiple users interacted, and labels in the corresponding set of labels identify whether the users acquired the respective items. For example, a piece of training data can include feature values associated with application data, customer data, channel interaction data, and/or financial branch/location data associated with a user and an item the user interacted with. The label can be, for example, a flag or indicator (e.g., 0 or 1) indicating whether the user acquired the item or not. The machine learning model can be trained by optimizing a loss function based on a difference between the model's output during training and the corresponding label.

As illustrated, the predictive model 108 can transmit the model output (e.g., output probability and/or the feature values) to the score computation engine 112. The score computation engine 112 can use the model output to compute feature scores for a first set of features of the predictive model 108, where a score for a particular feature represents a degree to which the particular feature contributed to the model output. In some cases, the feature scores can be numerical values within a predefined range. For example, the feature scores can be Shapley values, each Shapley value corresponding to a respective feature. A Shapley value of a feature can represent the feature's contribution to the model's output probability. In some cases, a Shapley value of a feature can be calculated by multiplying the weight of the feature with the feature value corresponding to the feature. The weight of the feature can be obtained by training the predictive model 108, whereas the feature value can be computed from the set of data received from the data source(s) 120. In such implementations, a high Shapley value indicates a great contribution to the model's output probability, whereas a low Shapley value indicates a small contribution to the model's output probability.

In some implementations, the first set of features can be selected from numerous features represented by the predictive model 108. The first set of features can be selected by performing at least one of global analysis, local analysis, or correlation analysis. At a high level, the global analysis and local analysis can include identifying a subset of features from among the model's features, where the identification of the subset of features is based on features that have or are expected to have high contributions (e.g., having global feature importance or Shapley values at or above a particular threshold, a certain number of features having the highest Shapley values, etc.) to the output probabilities of the predictive model 108 (as further described in the following paragraphs). The correlation analysis can include reducing a set of features to a subset of features based on the correlations of the set of features (as further described in the following paragraphs).

In some cases, the global analysis, local analysis, and/or correlation analysis can be performed in any order. In some implementations, the correlation analysis can be performed prior to the global analysis and/or local analysis. In such implementation, the correlation analysis can reduce the model's features to a first subset of features, and then the global analysis and/or local analysis can further reduce the first subset of features to a second subset of features (which make up the first set of features). In some implementations, the correlation analysis can be performed after the global analysis and/or local analysis. In such implementation, the global analysis and/or local analysis can reduce the model's features to a first subset of features, and then the correlation analysis can further reduce the first subset of features to a second subset of features (which make up the first set of features).

In some cases, the global analysis can include identifying the features having high global feature importance (e.g., a non-negative numerical value) when the predictive model is trained. When the predictive model is trained using a plurality of samples, the predictive model can learn that some features are more important than others given all of the samples used to train the predictive model, and therefore such features have higher global feature importance than the other features. In some cases, the global feature importance can be, for example, the feature weights learned during the training of the predictive model. During training, the feature weight assigned to each feature can be adjusted in order to minimize the error between the predicted output and the actual output (e.g., label of a sample), and the feature weights can settle when the predictive model converges. In some implementations, the features can be ranked from the highest global feature importance to the lowest global feature importance. Then a certain number of top features on the ranked list (e.g., top features with highest feature weights) can be selected as the results of the global analysis. For example, the predictive model can be trained using 500 features, and each sample can have values corresponding to the 500 features. The global analysis can select, for example, 20 top features having highest global feature importance out of the 500 features. In some cases, the global analysis can be implemented using the component(s) (e.g., libraries) of PySpark. In some implementations, the predictive model can be retrained using just the features having high global feature importance, and therefore reducing the number of features that need to analyze for explaining the output probability of the predictive model.

By contrast, the local analysis can include analyzing one particular sample (e.g., an application of the user)'s Shapley values and selecting the features having high contributions (e.g., identifying the features having high absolute Shapley values for the particular sample). In some cases, the Shapley value of a feature can be a positive value, indicating the degree a feature increases the output probability. On the other hand, the Shapley value of a feature can be a negative value, indicating the degree a feature decreases the output probability. Accordingly, an absolute value of a Shapley value can indicate the impart of the corresponding feature to the output probability. As such, absolute Shapley values of the features of a sample can be calculated, and a certain number of features having the highest absolute Shapley values can be identified to explain the output probability. In some implementations, the subset of features can be determined based on both of the global analysis and the local analysis. That is, the subset of features can include a predetermined number of feature(s) determined by the global analysis, as well as a predetermined number of feature(s) determined by the local analysis.

In some cases, the correlation analysis can be used to reduce the number of features for computing Shapley values. In some implementations, the correlation analysis can determine that two or more features are correlated, and remove at least one of the two or more features from computing Shapley values. More specifically, a correlation matrix can be calculated for a set of features, where each element of the correlation matrix represents the correlation coefficient of two features. In some cases, computing the correlation coefficient of two features can be implemented using, for example, the component(s) (e.g., functions, libraries) of Panda. If the correlation coefficient of two features satisfy one or more conditions, the two features can be determined to be correlated. The one or more condition can include, for example, that the correlation coefficient meets or exceeds a predetermined threshold (e.g., 70%). For the two correlated features, the feature having higher contribution (e.g., higher global feature importance) to the output probability can be included in the list of features to compute Shapley values, whereas the feature having lower contribution can be excluded from the list. Accordingly, the number of features to compute Shapley values can be reduced.

In some cases, the correlation analysis can reduce the number of features through dimension reduction (e.g., PCA). In such implementations, the subset of features can be, for example, the principal components identified by PCA. For example, assuming that an original set of features includes 20 features and the correlation analysis identifies 16 principal components based on the 20 features, the subset of features can include 16 features (four features fewer than the original set of features).

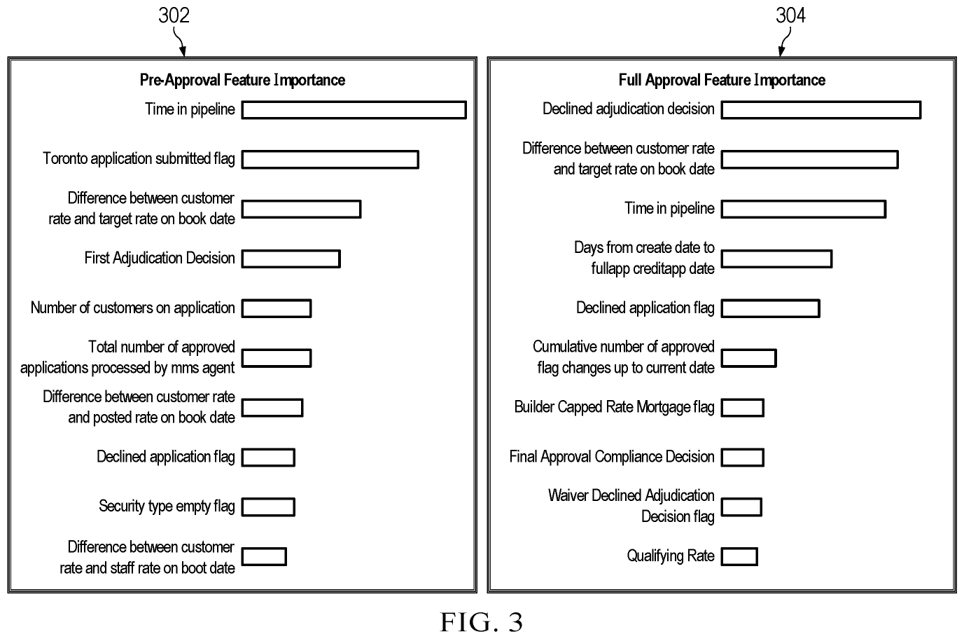

As noted, the customized recommendation can be generated at any stage during the item acquisition lifecycle. As the importance of features can vary at different stages of the lifecycle, the first set of features can be identified based on the stage of the item acquisition lifecycle. In some cases, a first set of features at a first stage and the first set of features at a second stage can include at least one different feature. FIG. 3 shows examples results to illustrate this (discussion of FIG. 2 will resume after this related description of FIG. 3).

FIG. 3 illustrates example features at different stages of the item acquisition lifecycle and their corresponding importance. As illustrated, a list of important features 302 prior to approvals of mortgage loans, as well as their importance (e.g., Shapley values) can be identified. Similarly, a list of important features 304 after approvals of mortgage loans, as well as their importance (e.g., Shapley values) can be identified. As illustrated, the features 302 and 304 are not identical. For example, prior to the approval of a mortgage loan, one of the most important features is time in pipeline, indicating that the processing time of the mortgage loan application can have a significant impact on the user's decision to acquire the mortgage loan before the approval of the mortgage loan. By contrast, after the approval of a mortgage loan, the difference between the user's desired interest rate and the interest rate provided by the financial institution is one of the most important features, indicating that this feature can significantly impact the user's decision to acquire the mortgage loan after approval of the mortgage loan.

In some cases, the features 302 and/or the features 304 can be the subset of features determined by global analysis and/or local analysis as described above. In such cases, the features 302 (or features 304) can be the top 10 features having the highest average Shapley values determined based on the global analysis as described above and samples prior to the approvals of mortgage loans (or after approvals of mortgage loans for features 304). In some cases, the features 302 and/or the features 304 can be the subset of features determined by correlation analysis as described above.

Returning to FIG. 2, in some cases, the output probability which indicates a likelihood that the user will acquire the particular item can be used to determine whether to generate a customization recommendation for the user. In some cases, a customization recommendation can be generated for users whose probabilities satisfy predetermined condition(s) (e.g., users whose probabilities fall in a certain probability interval). Accordingly, a customization recommendation may not be generated for users whose probabilities of obtaining the items are above a predetermined threshold (e.g., 75%) and/or users whose probabilities of obtaining the items are below a predetermined threshold (e.g., 25%). This can avoid generating and sending excessive customized recommendations for users who will likely obtain the items even without any customized recommendations, or for users who will unlikely obtain the items even with the customized recommendations. As a result, it can reduce significant quantity of computing and network resources stemming from generating and communicating those customized recommendations, as well as evaluating and responding to the users' reactions to the customized recommendations. In some cases, the probability threshold(s) can be static. For example, a threshold can be predetermined based on analyzing statistics of history data to identify the threshold above which a user will acquire the item even without a customized recommendation (or below which a user will not acquire the item even with a customized recommendation). In some cases, the probability threshold(s) can be dynamically determined. As an example, an initial threshold (e.g., 25%) below which a customized recommendation will not be generated can be set. After some customized recommendations are sent, the reactions to the customized recommendations can be analyzed to determine whether any adjustment to the initial threshold is needed. For example, if a number of users declined the customized recommendations and these users' probabilities are close to the initial threshold, it indicates that these users will unlikely acquire the items even with the customized recommendations. Accordingly, the initial threshold can be increased (e.g., to 30%) to reduce the generations of customized recommendations.

As illustrated, the recommendation system 102 can use a clustering model 110 (e.g., a k-means clustering algorithm) that identifies multiple clusters, and further use the computed feature scores (e.g., Shapley values) and/or the model output to assign the user to a particular cluster from among the multiple clusters. Each of the multiple clusters indicates a respective one or more attributes corresponding to users identified in the cluster (e.g., whether the user is price-sensitive, time sensitive, etc.).

In some implementations, the clustering model 110 can be an unsupervised machine learning model (e.g., a k-means clustering algorithm). The output of the clustering model 110, including, for example, the identified clusters, the feature scores of the user(s) in each cluster, and/or the output probabilities of the user(s) in each cluster, can be input into a supervised machine learning model (e.g., a decision tree) to determine one or more attributes corresponding to user(s) in each cluster. In some cases, the supervised machine learning model (e.g., a decision tree) can be trained using a set of training data, where the training data can include multiple sets of data relating to identified clusters and the characteristics of the user(s) in each cluster. For example, a piece of training data can include the feature scores of the user(s) and/or the output probabilities of the user(s) in each cluster. In addition, in some cases, a piece of training data can further include one or more of, for example, application data, customer data, channel interaction data, and/or financial branch/location data associated with the user(s) of each cluster. The label of the piece of training data can be, for example, one or more attributes corresponding to the user(s) in each cluster (e.g., whether the user(s) of a cluster are price-sensitive, time sensitive, etc.). The supervised machine learning model can be trained by optimizing a loss function based on a difference between the model's output during training and the corresponding label.

In some implementations, the clustering model 110 can be a supervised machine learning model, and the supervised machine learning model can be trained using a set of training data, where the training data can include multiple sets of data relating to multiple users and items with which the multiple users interacted. For example, a piece of training data can include Shapley values associated with a user and a particular item the user interacted with and/or the model output probability specifying a likelihood that the user would acquire the particular item. In addition, in some cases, a piece of training data can further include one or more of, for example, application data, customer data, channel interaction data, and/or financial branch/location data associated with a user. The label of the piece of training data can be, for example, one or more attributes corresponding to the user (e.g., whether the user is price-sensitive, time sensitive, etc.). The machine learning model can be trained by optimizing a loss function based on a difference between the model's output during training and the corresponding label.

In some cases, the recommendation system 102 can transmit the clustering result (e.g., one or more attributes corresponding to the user) to the recommendation customization engine 140, which can use the clustering result (and in some implementations, the computed feature scores) to generate a customized recommendation for the user, where the customized recommendation specifies a customized offer for the user to acquire the particular item. For example, the customized recommendation for a price-sensitive user can include a sign-up bonus that gives the user a certain credit toward the mortgage financing. For another example, the customized recommendation for a time-sensitive user can include a shortened processing time and/or a guaranteed completion time of a mortgage financing application.

In some implementations, in addition to the clustering result, the computed feature scores can be used to augment the customized recommendation. In some cases, the clustering result can provide general characteristic(s) of the user, while the computed feature scores can provide more insights/reasoning of the general characteristic(s) of the user. As an example, the clustering result can indicate that the user is a cost-sensitive user, and the computed feature scores can indicate the specific type(s) of cost (e.g., interest cost, mortgage origination cost, etc.) that highly contribute to the user's probability of acquiring the item. For example, the computed features scores can indicate that the interest cost is a more significant reason than the origination cost for the user's low probability of acquiring a mortgage loan. In such case, a customization recommendation including a lower interest cost can be generated for the user.

In some cases, the recommendation customization engine 140 can maintain mapping relationships (e.g., a database, a data table, a graph database, etc.) between user attributes and corresponding customized recommendations. For example, a user attribute of “price-sensitive user” can be mapped to the customized recommendation of providing a sign-up bonus that gives the user a certain credit toward the mortgage financing. So, given one or more user attributes, the recommendation customization engine 140 can query the mapping relationships to determine the customized recommendation(s) corresponding to the user attribute(s).

In some cases, the recommendation customization engine 140 can transmit the user attribute(s) to an analyst's system (not shown) where a human verifier can determine a customized recommendation for the user to obtain the particular item. In some cases, the recommendation customization engine 140 can transmit the customized recommendation to the analyst's system where a human verifier can evaluate and validate the customized recommendation. The human verifier's customized recommendation and/or validation can subsequently be provided (e.g., in a message) to the recommendation customization engine 140 and/or the client 160.

As illustrated, the recommendation customization engine 140 can transmit the customized recommendation to the client 160. In some cases, the user can perform operation(s) on the customized recommendation (e.g., acceptance or rejection) on the client 160. The recommendation system 102 can detect the user operation(s) and refine the predictive model 108 and/or the clustering model 110 based on the user operation(s). For example, assuming that the user accepted the customized recommendation, a new training data having a label indicating high probability (e.g., greater than 50%) can be generated for re-training the predictive model 108. In addition, the acceptance from the user indicates that the predicted user attribute(s)/cluster is affirmed, so a new training data including a label indicating the predicted user attribute(s) can be generated and used for re-training the clustering model 110. As another example, assuming that the user rejected the customized recommendation, a new training data having a label indicating a low probability (e.g., lower than 50%) can be generated for re-training the predictive model 108. In some cases, the user can indicate the reason(s) why they rejected the customized recommendation, such as the mortgage financing cost is too high, the processing time is too long, etc. These reason(s) (which can be transmitted in a message back to the recommendation system) can be used by the system to adjust user attribute(s) of the user and the adjusted user attribute(s) can be label(s) of the new training data used to re-train the clustering model 110. In this manner, actual recommendation data and user responses to the same can be used to iteratively train the predictive model as well as the clustering model, e.g., in an online manner, thereby continuously facilitating robust and accurate models.

In some cases, the predictive model 108 and/or the clustering model 110 can be refined immediately upon the occurrence of a particular event. For example, the predictive model 108 and/or the clustering model 110 can be re-trained each time the user operation(s) results in generation of new training data for the predictive model 108 and/or the clustering model 110. In some cases, the predictive model 108 and/or the clustering model 110 can be re-trained periodically (e.g., every seven days, thirty days, etc.) and/or re-trained when a certain amount of training data has been generated.

Additionally, in some implementations, the accuracy of the predictive model 108 and/or the clustering model 110 can be measured at predetermined time intervals (e.g., every seven days, thirty days, etc.) and based on the determined accuracy, the predictive model 108 and/or the clustering model 110 can be re-trained or refined to improve the overall accuracy and/or performance of the model(s). For example, the accuracy of the model(s) can be a ratio that is equal to a quantity of customized recommendations accepted by users divided by a total quantity of customized recommendations provided to the users. If the accuracy of the model(s) satisfies (e.g., meets or below) a predetermined threshold, the predictive model 108 and/or the clustering model 110 can be re-trained or refined using new training data.

In some cases, one or more operations described above can be implemented using the component(s) (e.g., libraries) of PySpark. For example, computing the feature scores can be implemented based on a PySpark's library associated with Shapley values. For another example, identifying the cluster can be implemented based on the k-means function included in PySpark.

It should be noted that FIG. 2 only provides an example of the flows and interactions between an example set of components performing the operations described herein. Additional, alternative, or different combinations of components, interactions, and operations can be used in different implementations.

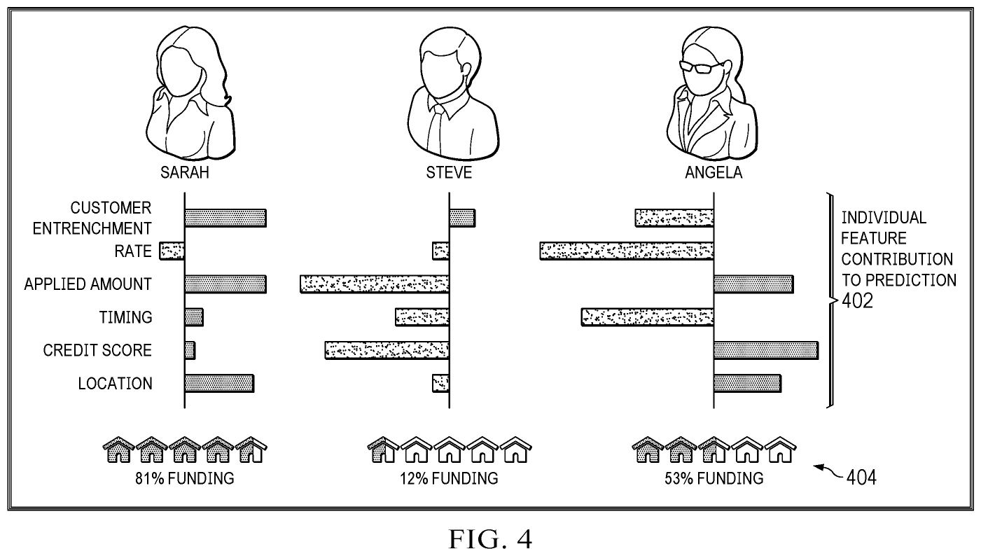

FIG. 4 illustrates example results of users' feature scores and probabilities. As illustrated, a probability 404 is generated (e.g., by the predictive model 108) for each user indicating a likelihood that the user will obtain a mortgage loan. In addition, six features 402, including customer entrenchment, rate, applied amount, timing, credit score, and location, are selected as the features having high contributions (or are expected to have high contributions) to the model's output probabilities. In some cases, the six features can be identified based on the operations described above with respect to identifying the first set of features. The six features' corresponding feature scores 402 are visualized as bar diagrams indicating each individual feature's relative contribution to the output probability. The feature scores can have a predefined range of −1 to 1. For example, regarding the feature of customer entrenchment, Sarah can have a feature score of 0.8, Steve can have a feature score of 0.2, and Angela can have a feature score of −0.5.

As noted, a cluster can be identified for each user. For example, Sarah may be included in the cluster of cost-sensitive users, whereas Steve and Angela may be included in the cluster of time-sensitive users. In some cases, a customized recommendation can be generated for each user. For example, a customized recommendation of providing a sign-up bonus to offset the gap between Sarah's desired rate and the offered rate can be generated and sent to Sarah. For another example, a customized recommendation of providing a shorted and/or guaranteed processing time can be generated and sent to Steve. In some cases, a customization recommendation can be generated for users whose probabilities satisfy predetermined condition(s), such as between 25% and 75%. In such case, a customized recommendation can be generated for Angela, but not Sarah or Steve.

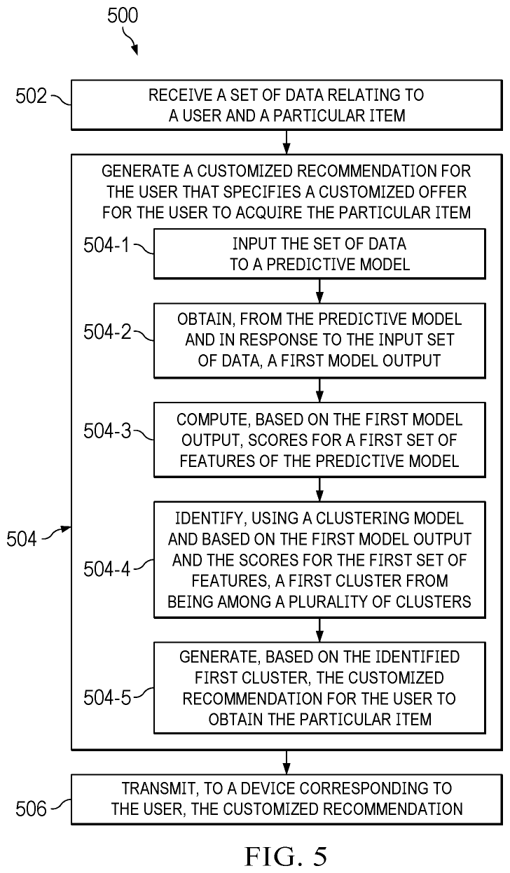

FIG. 5 is a flow diagram of an example method 500 for customizing a recommendation for a user to obtain an item based on machine learning and clustering techniques. As explained further below, this flow diagram describes generating a probability indicating whether a user will acquire a particular item, computing feature scores associated with features having high contributions to the output probability, inputting the feature scores and/or the output probability to a clustering model to identify user attribute(s), and subsequently customizing a recommendation for the user to obtain the particular item based on the user attribute(s). It should be understood that method 500 can be performed, for example, by any suitable system, environment, software, and hardware, or a combination of systems, environments, software, and hardware as appropriate. In some instances, method 500 can be performed by a system including one or more components of the environment 100, including, among others, the recommendation system 102 and the recommendation customization engine 140, or portions thereof, described in FIG. 1, as well as other components or functionality described in other portions of this description. In other instances, the method 500 can be performed by a plurality of connected components or systems, such as those illustrated in FIG. 2. Any suitable system(s), architecture(s), or application(s) can be used to perform the illustrated operations.

At 502, as described with reference to FIGS. 1-4, a set of data relating to a user and a particular item can be received via a network interface and for the user that is interacting with the particular item of a provider. In some cases, the set of data relating to the user and the particular item can be obtained at a particular point during a lifecycle for acquisition of the particular item, and where the particular point during the lifecycle includes (1) a point in the lifecycle when the user makes an initial request for information regarding the particular item or (2) a point in the lifecycle when the user has submitted an application requesting an offer for the particular item.

At 504, as described with reference to FIGS. 1-4, a customized recommendation can be generated for the user that specifies a customized offer for the user to acquire the particular item. In some cases, the step 504 can include sub-steps from 504-1 to 504-5.

At 504-1, as described with reference to FIGS. 1-4, the set of data can be input to a predictive model that generates an output probability specifying a likelihood that the user will obtain an item of the provider. In some cases, method 500 can include training the predictive model using a set of training data and a corresponding set of labels, where the set of training data can include a plurality of sets of data relating to multiple users and items with which the multiple users interacted, and each label in the corresponding set of labels can identify whether a user of the multiple users acquired a respective item.

At 504-2, as described with reference to FIGS. 1-4, a first model output specifying a particular likelihood that the user will obtain the particular item can be obtained from the predictive model and in response to the input set of data. At 504-3, scores for a first set of features of the predictive model can be computed based on the first model output, where a score for a particular feature represents a degree to which the particular feature contributed to the first model output. In some cases, the scores for the first set of features can include Shapley values for the first set of features. In some examples, the first set of features can be identified from among the plurality of features based on historical data of Shapley values for a plurality of features. In some cases, the identification of the first set of features can be based on features with Shapley values that have contributions to the first model output of the predictive model that satisfy a predetermined threshold, and where the method 500 can include reducing a first subset of features to a second subset of features using a correlation analysis that correlates one or more features within the first subset of features, where the second subset of features is the first set of features. In some cases, the particular item can include a financial product, and where the first set of features can include at least one of a desired interest rate of the user, an interest rate of the financial product, applied loan amount of the user, a desired processing time of the user for an application requesting an offer for the financial product, a credit score of the user, or a location of the user.

At 504-4, as described with reference to FIGS. 1-4, a first cluster can be identified from among a plurality of clusters using a clustering model and based on the first model output and the scores for the first set of features, where each of the plurality of clusters can indicate one or more attributes corresponding to users in the cluster. In some cases, the clustering model can include a k-means clustering algorithm.

At 504-5, as described with reference to FIGS. 1-4, the customized recommendation for the user to obtain the particular item can be generated based on the identified first cluster. In some cases, generating the customized recommendation can include generating, based on the identified first cluster and the scores for the first set of features, the customized recommendation.

At 506, as described with reference to FIGS. 1-4, the customized recommendation can be transmitted via the network interface and to a device corresponding to the user. In some cases, method 500 can include determining accuracy of the predictive model at predetermined time intervals, and triggering a re-training of the predictive model in response to determining that the accuracy does not satisfy a predetermined threshold. In some examples, method 500 can include comparing actual outcomes indicating whether particular users acquired items with corresponding predicted outputs generated by the predictive model indicating whether the particular users will acquire the items, and triggering a re-training of the predictive model in response to determining that the actual outcomes differ from the predicted outputs by a predetermined threshold. In some examples, method 500 can include detecting one or more user operations of the user in response to the customized recommendation, and generating, based on the one or more user operations, training data for re-training at least one of the predictive model or the clustering model. In some instances, the one or more user operations can include at least one of accepting the customized recommendation or rejecting the customized recommendation.

The techniques described herein can be used in the context of financial product offer personalization, in particular, using machine learning and clustering techniques to generate personalized offers that incentivize users to purchase a particular financial product. However, the techniques described herein could be used in offer/recommendation personalization for any product, item, or service (i.e., it need not be limited to financial product offer personalization). One skilled in the art will appreciate that the techniques described herein are not limited to just these applications but can be applicable in other contexts.

For example, in some implementations, the techniques described herein for using machine learning and clustering techniques to generate personalized offers can be extended to making personalized offers to job candidates. In one example use case, the techniques described herein can be used to generate a probability indicating whether a job candidate will accept a job offer based on a set of data related to the job candidate and the job opening. In addition, the techniques described herein can be used to compute feature scores (e.g., Shapley values) associated with features of the predictive model in generating the output probability. The feature scores and/or the output probability can be input into a clustering model, which can identify a cluster from among a plurality of clusters, each of the plurality of clusters indicating one or more attributes corresponding to job candidates in the cluster. The identified one or more attributes can subsequently be used to customize a personalized offer (e.g., providing a sign-on bonus, providing remote work option, providing extra vacation time, etc.) for the job candidate.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system comprising:
at least one memory storing instructions;
a network interface; and
at least one hardware processor interoperably coupled with the network interface and the at least one memory, wherein execution of the instructions by the at least one hardware processor causes performance of operations comprising:
receiving, via the network interface and for a user who is interacting with a particular item of a provider, a set of data relating to the user and the particular item;
generating a customized recommendation for the user that specifies a customized offer for the user to acquire the particular item, wherein the generating comprises:
inputting the set of data to a predictive model that generates an output probability specifying a likelihood that the user will obtain an item of the provider;
obtaining, from the predictive model and in response to the input set of data, a first model output specifying a particular likelihood that the user will obtain the particular item;
computing, based on the first model output, scores for a first set of features of the predictive model, wherein a score for a particular feature represents a degree to which the particular feature contributed to the first model output;
identifying, using a clustering model and based on the first model output and the scores for the first set of features, a first cluster from among a plurality of clusters, wherein each of the plurality of clusters indicates one or more attributes corresponding to users in the cluster; and
generating, based on the identified first cluster, the customized recommendation for the user to obtain the particular item; and
transmitting, via the network interface and to a device corresponding to the user, the customized recommendation.

2. The system of claim 1, wherein the scores for the first set of features comprises Shapley values for the first set of features.

3. The system of claim 2, the operations further comprising:
identifying, based on historical data of Shapley values for a plurality of features, the first set of features from among the plurality of features.

4. The system of claim 3, wherein the identification of the first set of features is based on features with Shapley values that have contributions to the first model output of the predictive model that satisfy a predetermined threshold, and wherein the operations comprise:
reducing a first subset of features to a second subset of features using a correlation analysis that correlates one or more features within the first subset of features, wherein the second subset of features is the first set of features.

5. The system of claim 1, wherein generating the customized recommendation comprises:
generating, based on the identified first cluster and the scores for the first set of features, the customized recommendation.

6. The system of claim 1, wherein the clustering model comprises a k-means clustering algorithm.

7. The system of claim 1, the operations further comprising:
training the predictive model using a set of training data and a corresponding set of labels, wherein the set of training data includes a plurality of sets of data relating to multiple users and items with which the multiple users interacted, and each label in the corresponding set of labels identifies whether a user of the multiple users acquired a respective item.

8. The system of claim 1, wherein the set of data relating to the user and the particular item is obtained at a particular point during a lifecycle for acquisition of the particular item and wherein the particular point during the lifecycle includes (1) a point in the lifecycle when the user makes an initial request for information regarding the particular item or (2) a point in the lifecycle when the user has submitted an application requesting an offer for the particular item.

9. The system of claim 1, the operations further comprising:
determining accuracy of the predictive model at predetermined time intervals; and
triggering a re-training of the predictive model in response to determining that the accuracy does not satisfy a predetermined threshold.

10. The system of claim 1, the operations further comprising:
comparing actual outcomes indicating whether particular users acquired items with corresponding predicted outputs generated by the predictive model indicating whether the particular users will acquire the items; and
triggering a re-training of the predictive model in response to determining that the actual outcomes differ from the predicted outputs by a predetermined threshold.

11. The system of claim 1, the operations comprising:
detecting one or more user operations of the user in response to the customized recommendation; and
generating, based on the one or more user operations, training data for re-training at least one of the predictive model or the clustering model.

12. The system of claim 11, wherein the one or more user operations comprise at least one of accepting the customized recommendation or rejecting the customized recommendation.

13. The system of claim 1, wherein the particular item comprises a financial product, and wherein the first set of features comprise at least one of a desired interest rate of the user, an interest rate of the financial product, applied loan amount of the user, a desired processing time of the user for an application requesting an offer for the financial product, a credit score of the user, or a location of the user.

14. A computer-implemented method, comprising:
receiving, via a network interface and for a user who is interacting with a particular item of a provider, a set of data relating to the user and the particular item;
generating a customized recommendation for the user that specifies a customized offer for the user to acquire the particular item, wherein the generating comprises:
inputting the set of data to a predictive model that generates an output probability specifying a likelihood that the user will obtain an item of the provider;
obtaining, from the predictive model and in response to the input set of data, a first model output specifying a particular likelihood that the user will obtain the particular item;
computing, based on the first model output, scores for a first set of features of the predictive model, wherein a score for a particular feature represents a degree to which the particular feature contributed to the first model output;
identifying, using a clustering model and based on the first model output and the scores for the first set of features, a first cluster from among a plurality of clusters, wherein each of the plurality of clusters indicates one or more attributes corresponding to users in the cluster; and
generating, based on the identified first cluster, the customized recommendation for the user to obtain the particular item; and
transmitting, via the network interface and to a device corresponding to the user, the customized recommendation.

15. The computer-implemented method of claim 14, wherein the scores for the first set of features comprises Shapley values for the first set of features.

16. The computer-implemented method of claim 15, the method further comprising:
identifying, based on historical data of Shapley values for a plurality of features, the first set of features from among the plurality of features.

17. The computer-implemented method of claim 16, wherein the identification of the first set of features is based on features with Shapley values that have contributions to the first model output of the predictive model that satisfy a predetermined threshold, and wherein the method comprises:
reducing a first subset of features to a second subset of features using a correlation analysis that correlates one or more features within the first subset of features, wherein the second subset of features is the first set of features.

18. The computer-implemented method of claim 14, wherein generating the customized recommendation comprises:
generating, based on the identified first cluster and the scores for the first set of features, the customized recommendation.

19. The computer-implemented method of claim 14, wherein the clustering model comprises a k-means clustering algorithm.

20. A non-transitory, computer-readable medium storing computer-readable instructions, that upon execution by at least one hardware processor, cause performance of operations, comprising:
receiving, via a network interface and for a user that is interacting with a particular item of a provider, a set of data relating to the user and the particular item;
generating a customized recommendation for the user that specifies a customized offer for the user to acquire the particular item, wherein the generating comprises:
inputting the set of data to a predictive model that generates an output probability specifying a likelihood that the user will obtain an item of the provider;
obtaining, from the predictive model and in response to the input set of data, a first model output specifying a particular likelihood that the user will obtain the particular item;
computing, based on the first model output, scores for a first set of features of the predictive model, wherein a score for a particular feature represents a degree to which the particular feature contributed to the first model output;
identifying, using a clustering model and based on the first model output and the scores for the first set of features, a first cluster from among a plurality of clusters, wherein each of the plurality of clusters indicates one or more attributes corresponding to users in the cluster; and
generating, based on the identified first cluster, the customized recommendation for the user to obtain the particular item; and
transmitting, via the network interface and to a device corresponding to the user, the customized recommendation.
